(19) United States
(12) Patent Application Publication
(10) Pub. No.: US 2018/0215336 A1
(43) Pub. Date: Aug. 2, 2018

(54) VEHICLE COLLISION SENSOR AND VEHICLE COLLISION DETECTION DEVICE USING THE SAME

(71) Applicant: DENSO CORPORATION, Kariya-city, Aichi-pref. (JP)

(72) Inventors: Asei Wakabayashi, Kariya-city (JP); Takatoshi Tanabe, Kariya-city (JP); Kazuhisa Hashimoto, Kariya-city (JP)

(21) Appl. No.: 15/742,354

(22) PCT Filed: Jul. 5, 2016
(86) PCT No.: PCT/JP2016/003192

§ 371 Date: Jan. 5, 2018

(30) Foreign Application Priority Data
Jul. 8, 2015 (JP) 2015-136752

(51) Int. Cl. B60R 21/0136; B60R 19/48; B60R 21/34; G01L 5/00; G01L 1/16

(52) U.S. Cl. CPC B60R 21/0136; B60R 19/483; B60R 2021/0004; G01L 5/0052; G01L 1/16; B60R 21/34

(57) ABSTRACT

A second-time collision position estimator section estimates a second-time collision position that is a position at which an occupant on a two-wheel mobile object has a second-time collision, based on a relative vector estimated by a relative vector estimator section and a first-time collision position identified by a first-time collision position identifier section. An operation instructor section operates an external protection device, which is determined to be able to protect the occupant on the two-wheel mobile object based on the second-time collision position estimated by the second-time collision position estimator section.

### CROSS REFERENCE TO RELATED APPLICATION

This application is based on Japanese Patent Application No. 2015-136752 filed on Jul. 8, 2015, the disclosure of which is incorporated herein by reference.

### TECHNICAL FIELD

The present disclosure relates to a collision sensor for a vehicle, which detects a collision of, for example, a pedestrian to the vehicle, and a collision detection device using the collision sensor for a vehicle.

### BACKGROUND ART

There is a conventional art regarding a collision detection device for a vehicle, which detects a collision of a pedestrian to a front end of the vehicle. A shock absorber is disposed behind a bumper cover, and a tube for detection is arranged between the shock absorber and a cross member (for example, refer to Patent Literature 1). The collision detection device of the conventional art enables detection of a collision within a wide range of the bumper cover. In this conventional art, a collision of a pedestrian to the bumper cover is detected when a pressure more than or equal to a threshold value occurs in the tube for detection extending in the width direction of the vehicle.

### PRIOR ART LITERATURES

### Patent Literature

### Patent Literature 1: JP 2014-505629 A

### SUMMARY OF INVENTION

However, as a result of detailed investigation by the inventors, the inventors find that a collision may not accurately be detected by the collision detection device of the conventional art, because a collision to the front end of a vehicle is detected through the shock absorber. Specifically, when a collision occurs to the bumper cover at the front end of the vehicle, the shock caused by the collision is attenuated while travelling inside the absorber. For this reason, for example when the shock caused by a collision is small, the tube for detection arranged behind the absorber cannot accurately detect the rise in the pressure caused by the shock of the collision.

Moreover, in a vehicle including this kind of collision detection device, it is needed to determine whether it is necessary to actuate a pedestrian protection device. Specifically, it is necessary for the collision detection device to distinguish an object collided with the bumper cover. The collision detection device has to determine whether the collision object is a pedestrian or a bicycle, in this case, it is necessary to actuate the pedestrian protection device, and whether the collision object is a structure fixed to the ground such as a curbstone, in this case, it is unnecessary to actuate the pedestrian protection device. However, it is difficult to distinguish the collision object for the tube for detection, because the pressure in the tube for detection rises uniformly by collision irrespective of the kind of the collision object.

It is an object of the present disclosure to provide a vehicle collision sensor which accurately detects a collision to a vehicle, and a vehicle collision detection device using the vehicle collision sensor.

According to an aspect of the present disclosure, a vehicle collision sensor that detects a collision to a bumper cover disposed at a front part of a vehicle includes a piezoelectric polymer film which forms an output voltage corresponding to a deformation amount of the bumper cover. The piezoelectric polymer film is made of piezoelectric polymer material to which at least one of a stretching process and a polarizing processes is performed in a predetermined treatment direction. The piezoelectric polymer film is attached to an internal surface of the bumper cover so that the predetermined treatment direction matches the width direction of the vehicle and that the predetermined treatment direction does not match the up-and-down direction of the vehicle.

Accordingly, the vehicle collision sensor includes the piezoelectric polymer film which generates the output voltage corresponding to the deformation amount of the bumper cover. Thereby, the collision to the bumper cover of the vehicle can be detected based on the output voltage which is directly affected by the deformation amount of the bumper cover.

Moreover, the piezoelectric polymer film is attached to the bumper cover so that the predetermined treatment direction matches the vehicle width direction and does not match the up-and-down direction. Therefore, the output voltage generated by the piezoelectric polymer film in response to the deformation of the bumper cover in the vehicle width direction can be increased, and the output voltage generated by the piezoelectric polymer film in response to the deformation in the up-and-down direction can be reduced. Accordingly, a difference between the output voltages can be increased. Thus, by setting a voltage threshold value between the output voltages or between the detection voltages, a collision with a pedestrian can be certainly detected by the deformation of the bumper cover in the vehicle width direction, without detecting a collision with an object fixed to the ground, which deforms the bumper cover in the up-and-down direction.

Moreover, a vehicle collision detection device includes the vehicle collision sensor, and a collision determining part that compares the output voltage formed by the piezoelectric polymer film or a detection voltage formed based on the output voltage with a predetermined voltage threshold value. The collision determining part determines that a collision is generated to require an actuation of a protection device which protects an object collided to the bumper cover of the vehicle when the output voltage or the detection voltage is more than or equal to the voltage threshold value.

Accordingly, the collision determining part detects the collision to the bumper cover of the vehicle when the output voltage or the detection voltage is more than or equal to the voltage threshold value, by comparing the output voltage formed by the piezoelectric polymer film or the detection voltage formed based on the output voltage with the predetermined voltage threshold value. Thereby, the collision to the bumper cover of the vehicle can be accurately detected based on the output voltage or the detection voltage which is directly affected by the deformation amount of the bumper cover.

The vehicle collision sensor and the vehicle collision detection device using the vehicle collision sensor are aimed to detect all collisions which require actuation of a pedestrian protection device protecting not only a pedestrian but a bicycle and a stroller.

### BRIEF DESCRIPTION OF DRAWINGS

FIG. 1 is a plan view illustrating a vehicle in which a pedestrian protection system according to an embodiment is attached.

FIG. 2 is a cross-sectional view taken along a line II-II of FIG. 1.

FIG. 3 is a block diagram illustrating a configuration of the pedestrian protection system.

FIG. 4 is a front view illustrating the vehicle in which a collision is generated to the bumper cover.

FIG. 5A is a side view illustrating a front part of the vehicle in a state where a simulated pedestrian collides with the bumper cover.

FIG. 5B is a side view illustrating a front part of the vehicle in a state where a simulated structure fixed on the ground collides with the bumper cover.

FIG. 6A is a graph illustrating a relation between a deformation amount of the bumper cover and the position in the vehicle width direction when a collision of FIG. 5A is generated.

FIG. 6B is a graph illustrating a relation between a deformation amount of the bumper cover and the collision position in the height direction when a collision of FIG. 5B is generated.

FIG. 7 is a perspective view illustrating a piezo film with a stretching treatment direction and a polarizing treatment direction.

FIG. 8 is a cutaway perspective view illustrating the piezo film of FIG. 7 attached to the front bumper.

FIG. 9 is a control flow chart of the pedestrian protection system of the embodiment.

### DESCRIPTION OF EMBODIMENTS

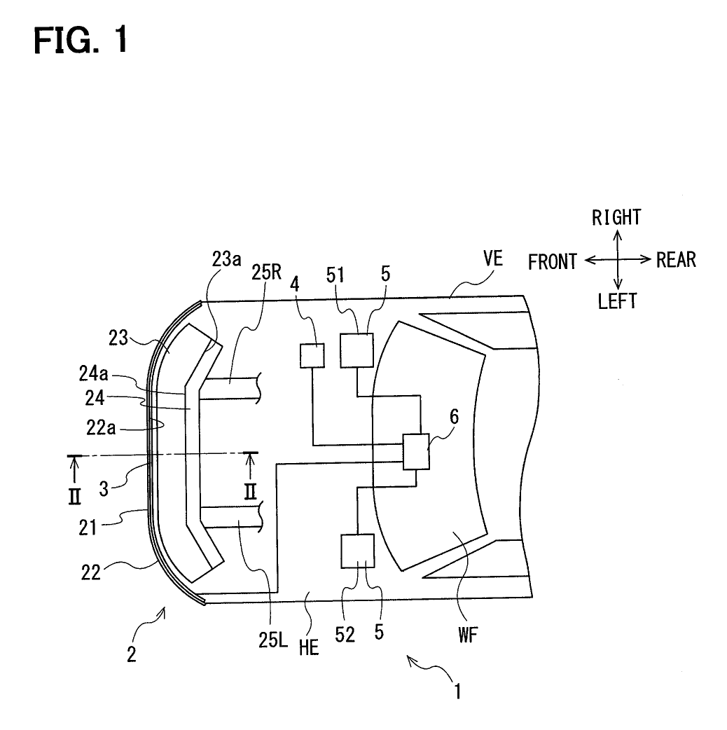

A pedestrian protection system 1 (corresponding to a vehicle collision detection device) according to an embodiment is explained based on FIG. 1 to FIG. 9. In each of the drawings, directions are defined relative to a vehicle VE. For example, an arrow direction of “front” represents a front side of the vehicle VE. Hereafter, a collision of a pedestrian to the vehicle VE is mainly explained. However, the vehicle collision detection device is aimed to detect all collisions, not only with the pedestrian, which require actuation of a pedestrian protection device 5.

### (Whole Configuration of Pedestrian Protection System)

As shown in FIG. 1, a front bumper 21 (corresponding to a front part of the vehicle) is attached to a front end of the vehicle VE. The front bumper 21 extends in the right-and-left direction, and includes a bumper cover 22 and a bumper absorber 23. The bumper cover 22 is made of synthetic resin material, and forms a design surface at the front part of the vehicle VE. The bumper absorber 23 is formed behind the bumper cover 22 as a shock absorber to absorb a collision to the front bumper 21. The bumper absorber 23 is made of foamed resin such as foamed polypropylene.

The bumper absorber 23 has a back end surface 23a that is attached to a front surface 24a of a bumper reinforcement 24. The bumper reinforcement 24 is a hollow reinforcing component extending in the right-and-left direction, and is made of metal material such as aluminium alloy. The bumper reinforcement 24 is fixed to front ends of a pair of right and left side members 25R and 25L extending in the front-and-rear direction. A body unit 2 is formed of the front bumper 21, the bumper reinforcement 24, and the side members 25R and 25L.

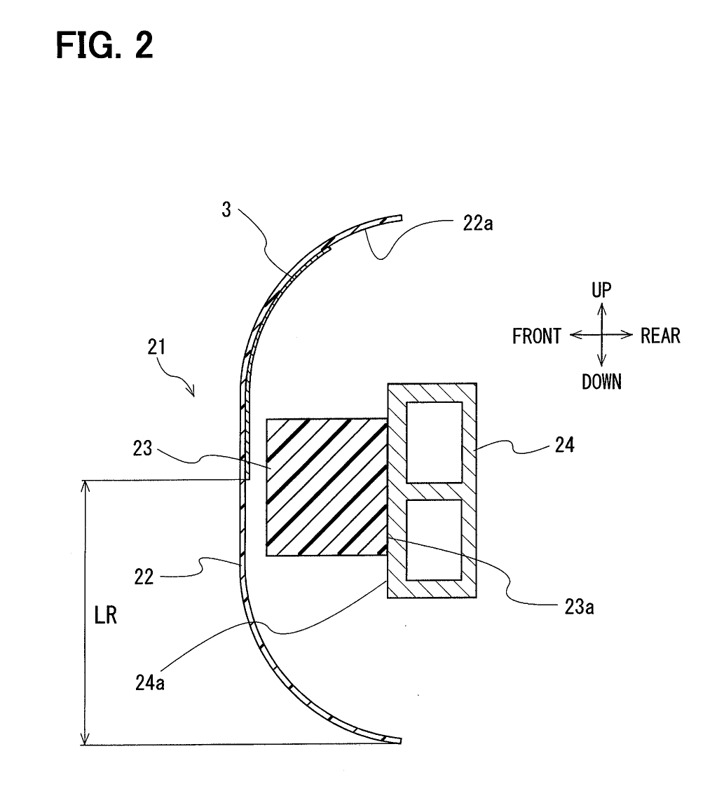

As shown in FIG. 1 and FIG. 2, a piezo film 3 (corresponding to a piezoelectric polymer film and a vehicle collision sensor) is attached to a back surface 22a (corresponding to an internal surface) of the bumper cover 22 by adhesives and the like. It is desirable that the piezo film 3 is attached on the vehicle VE to have a height corresponding to a pedestrian which may be collided. As shown in FIG. 2, the piezo film 3 is formed only within the upper half area of the bumper cover 22, and is not formed in the lower region LR which occupies an approximately lower half. The piezo film 3 is shaped in a thin film, and is made of piezoelectric polymer material such as polyvinylidene fluoride (PVDF), polypeptide, polylactic acid, polymethyl glutamate, or polybenzyl glutamate. The piezo film itself is well-known and disclosed in, for example, JP 2004-96980 A, JP 2007-212436 A and JP 2013-29368 A.

The piezo film 3 has a pair of electrodes (not shown), and a piezo element interposed between the electrodes. When a collision deforms the bumper cover 22, a tensile stress or a compression stress is applied to the piezo film 3, and an output voltage (henceforth referred to a piezo film voltage Vpz) is generated between the electrodes, in response to the deformation amount Q of the bumper cover 22. The piezo film 3 may be replaced with a pyroelectric (pyro) film attached to the bumper cover 22. The details of the piezo film 3 are mentioned later.

A speed sensor 4 for the vehicle VE is attached to a wheel or transmission of the vehicle VE, and detects the travelling speed of the vehicle VE.

The pedestrian protection device 5 (corresponding to a protection device) includes a cowl air bag device 51. When a pedestrian collides with the front bumper 21, the cowl air bag device 51 inflates a bag from the engine hood HE to the lower part of the front windshield WF, which are shown in FIG. 1, to protect a collision object such as a pedestrian.

Moreover, a pop-up hood 52 is also included in the pedestrian protection device 5. The pop-up hood 52 raises the back end of the engine hood HE, when a pedestrian collides with the front bumper 21. The engine hood HE serves as a shock absorber, and protects a collision object such as a pedestrian by preventing from colliding with a rigid component such as an engine.

### (Configuration of Pedestrian Protection ECU)

In the vehicle VE, a pedestrian protection ECU 6 is attached on a floor tunnel in front of a driver seat, which is not illustrated. The pedestrian protection ECU 6 is a control device having an input/output device, CPU, RAM, and the like, which are not illustrated. As shown in FIG. 1, the piezo film 3, the speed sensor 4, the cowl air bag device 51, and the pop-up hood 52 mentioned above are connected to the pedestrian protection ECU 6 by communication lines.

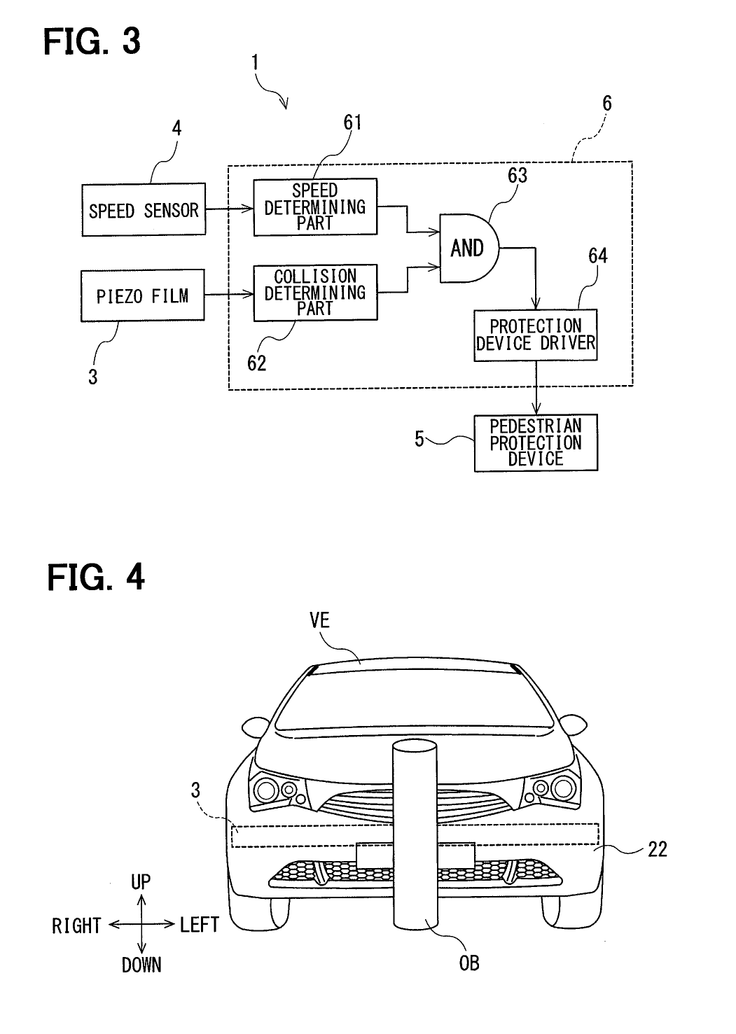

As shown in FIG. 3, the pedestrian protection ECU 6 includes a speed determining part 61, a collision determining part 62, AND circuit 63, and a protection device driver 64.

The speed determining part 61 is connected to the speed sensor 4. The speed determining part 61 determines whether a speed detection value Sdet by the speed sensor 4 is higher than or equal to a predetermined first speed threshold value Sth1 and is lower than or equal to a predetermined second speed threshold value Sth2. The speed determining part 61 outputs a high (H) signal, when the speed detection value Sdet is higher than or equal to the first speed threshold value Sth1 and is lower than or equal to the second speed threshold value Sth2.

The collision determining part 62 is connected to the piezo film 3. The collision determining part 62 compares the piezo film voltage Vpz inputted from the piezo film 3 with a predetermined voltage threshold value Vth. When the piezo film voltage Vpz Is higher than or equal to the voltage threshold value Vth (more than or equal to a voltage threshold value), the collision determining part 62 detects that a collision which requires the actuation of the pedestrian protection device 5 occurs in the bumper cover 22, and outputs the H signal. Alternatively, for an easy calculation, a predetermined detection voltage may be formed based on the piezo film voltage Vpz. In this case, when the detection voltage is more than or equal to the voltage threshold value Vth, the collision determining part 62 determines that a collision which requires the operation of the pedestrian protection device 5 occurs.

A pair of input terminals of AND circuit 63 are connected to the speed determining part 61 and the collision determining part 62. AND circuit 63 outputs H signal, when H signal is outputted from the speed determining part 61 and when H signal is outputted from the collision determining part 62.

The protection device driver 64 is connected to the output terminal of AND circuit 63. When H signal is outputted from AND circuit 63, the cowl air bag device 51 or the pop-up hood 52 is operated.

### (Characteristic in Deformation Amount of Bumper Cover at Collision Time)

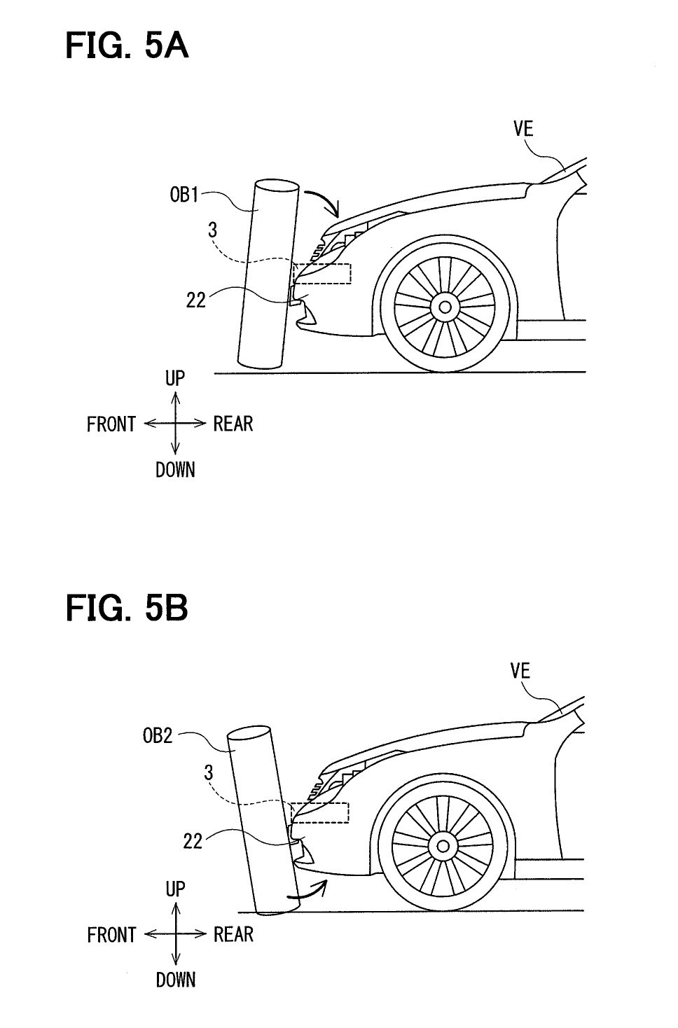

For easy understanding of characteristic in the piezo film voltage Vpz to be mentioned later, characteristic in the deformation amount Q of the bumper cover 22 caused by a collision is explained. As shown in FIG. 4, when the bumper cover 22 of the vehicle VE collides with a collision object OB from the front side, a deformation such as compression deformation or tensile deformation occurs in the bumper cover 22. In FIG. 4, the collision object OB is expressed to include a collision object OB1 shown in FIG. 5A and a collision object OB2 shown in FIG. 5B.

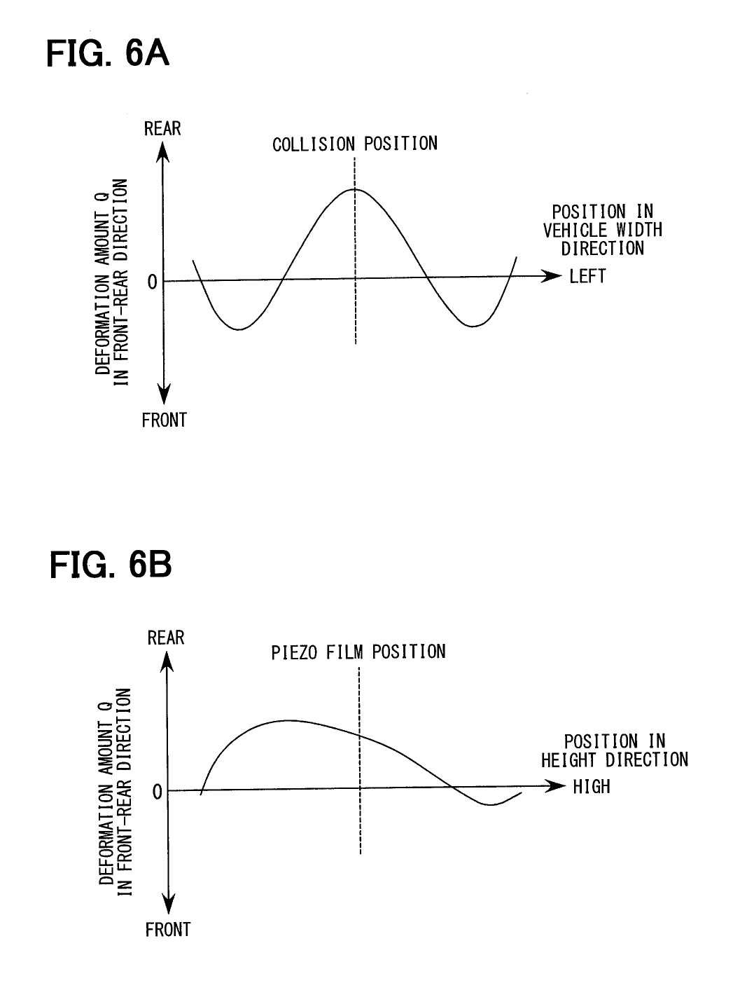

As shown in FIG. 5A, when the collision object OB1 is an object such as a pedestrian or a bicycle, which needs to actuate the pedestrian protection device 5, in many cases, the collision object OB1 falls from the upper side to the front end of the vehicle VE at the time of a collision. Thereby, as shown in FIG. 6A, the bumper cover 22 deforms rearward at the collision position in the vehicle width direction. As a result, the rearward deformation of the bumper cover 22 pulls the bumper cover 22 toward the both ends in the vehicle width direction.

In contrast, as shown in FIG. 5B, when a collision object OB2 is a structure fixed on the ground such as a pole and a curbstone, since the lower end of the collision object OB2 is fixed on the ground, the collision object OB2 enters the bottom clearance of the vehicle VE in many cases at the time of a collision. For this reason, as shown in FIG. 6B, the bumper cover 22 is pulled downward at the collision position.

### (Characteristics of Piezo Film Voltage)

The piezo film 3 is formed by performing a stretching process and a polarizing process to a piezoelectric polymer material having a thin film shape. The stretching process means a treatment applying tensile stress in a fixed direction while a certain amount of heating is conducted to the piezoelectric polymer material, so as to orient molecule chains in one direction. The polarizing process means a treatment applying high voltage to the piezoelectric polymer material so as to orient spontaneous polarization directions in a fixed direction. Hereafter, a direction in which the piezoelectric polymer material is pulled in the stretching process is called as a stretching treatment direction, and a direction in which the voltage is applied to the piezoelectric polymer material in the polarizing process is called as a polarizing treatment direction. The stretching treatment direction and the polarizing treatment direction are also called as a predetermined treatment direction.

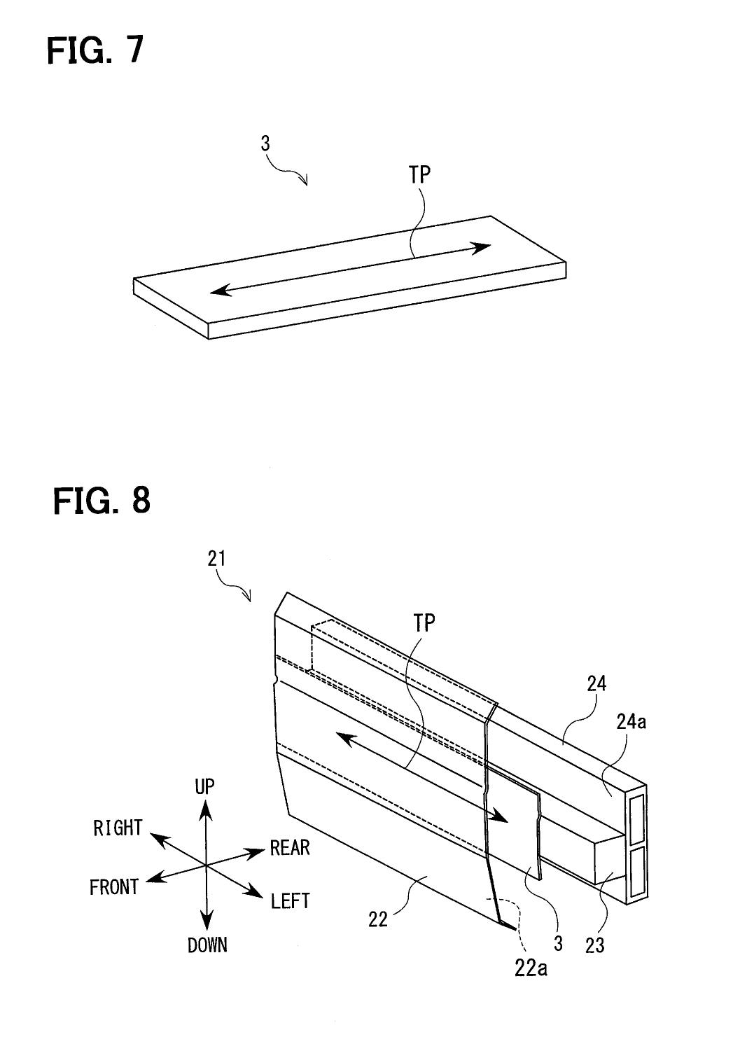

In this embodiment, both the stretching treatment direction and the polarizing treatment direction match the longitudinal direction of the piezo film 3. In FIG. 7, the stretching treatment direction and the polarizing treatment direction are shown in an arrow direction TP. The piezo film 3 can acquire piezoelectricity when the stretching process or the polarizing process is performed. After the treatment, a predetermined voltage can be generated by a deformation in the stretching treatment direction or the polarizing treatment direction. A method of the stretching process and a method of the polarizing process for piezoelectric polymer material are well-known and disclosed by, for example, JP 2010-123845 A, JP 2010-18726, and JP 2013-188667 A, so the explanation is omitted.

As shown in FIG. 8, the piezo film 3 to which the stretching process and the polarizing process were performed is attached to the bumper cover 22 such that the stretching treatment direction and the polarizing treatment direction match the width direction (right-and-left direction) of the vehicle VE. Moreover, the piezo film 3 is attached to the bumper cover 22 such that both of the stretching treatment direction and the polarizing treatment direction do not match the up-and-down direction. Thereby, the piezo film 3 is able to form comparatively large piezo film voltage Vpz by a deformation such as compression deformation or tensile deformation in the vehicle width direction of the bumper cover 22. In contrast, the piezo film voltage Vpz generated by the piezo film 3 in response to a deformation of the bumper cover 22 in the up-and-down direction or in the front-and-rear direction is remarkably reduced.

As mentioned above, when a pedestrian or a bicycle collides to the bumper cover 22, the bumper cover 22 is pulled in the vehicle width direction. Therefore, in this case, the deformation direction of the bumper cover 22 matches the stretching treatment direction and the polarizing treatment direction of the piezo film 3, and the piezo film 3 generates the piezo film voltage Vpz in response to the deformation amount Q of the bumper cover 22 in the vehicle width direction.

In contrast, when the collision object to the bumper cover 22 is a structure fixed on the ground such as a curbstone, the bumper cover 22 is pulled downward. Therefore, in this case, the deformation direction of the bumper cover 22 differs from the stretching treatment direction and the polarizing treatment direction of the piezo film 3, such that the piezo film voltage Vpz generated from the piezo film 3 is reduced.

### (Control Method of Pedestrian Protection System)

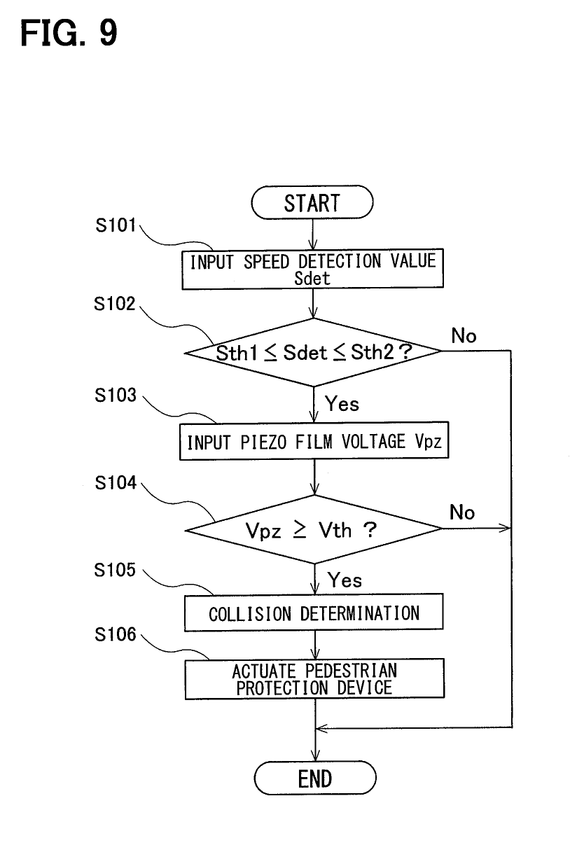

A control method of the pedestrian protection system 1 by the pedestrian protection ECU 6 is explained based on FIG. 9. First, the speed detection value Sdet of the vehicle VE is inputted from the speed sensor 4 to the speed determining part 61 (S101). Next, it is determined by the speed determining part 61 whether the speed detection values Sdet is larger than or equal to the first speed threshold values Sth1 and smaller than or equal to the second speed threshold value Sth2 (S102). When it is determined that the speed detection value Sdet is smaller than the first speed threshold value Sth1 or larger than the second speed threshold value Sth2, this control flow is ended. When it is determined that the speed detection values Sdet is more than or equal to the first speed threshold values Sth1 and less than or equal to the second speed threshold value Sth2, the piezo film voltage Vpz is inputted towards the collision determining part 62 from the piezo film 3 (S103).

It is determined whether the piezo film voltage Vpz inputted into the collision determining part 62 is more than or equal to the voltage threshold value Vth (S104). The voltage threshold value Vth is set between the piezo film voltage Vpz generated when a pedestrian or a bicycle collides with the bumper cover 22 and the piezo film voltage Vpz generated when a structure fixed to the ground collides with the bumper cover 22. When it is determined that the piezo film voltage Vpz is more than or equal to the voltage threshold value Vth, it is determined that a collision which needs the operation of the pedestrian protection device 5 is generated in the bumper cover 22 (S105), and the pedestrian protection device 5 is actuated (S106). When it is determined that the piezo film voltage Vpz is less than the voltage threshold value Vth in S104, this control flow is ended.

According to this embodiment, the vehicle collision sensor includes the piezo film 3 which generates the piezo film voltage Vpz in response to the deformation amount Q of the bumper cover 22. The collision determining part 62 compares the piezo film voltage Vpz formed by the piezo film 3 with the predetermined voltage threshold value Vth. When the piezo film voltage Vpz is more than or equal to the voltage threshold value Vth, it is determined that a collision occurs to the bumper cover 22 of the vehicle VE. Thereby, it can be correctly detected that the collision which needs the operation of the pedestrian protection device 5 is generated in the bumper cover 22 of the vehicle VE based on the piezo film voltage Vpz which is directly affected by the deformation amount Q of the bumper cover 22.

Moreover, the piezo film 3 is attached to the bumper cover 22 so that the stretching treatment direction and the polarizing treatment direction match the vehicle width direction. Thereby, the piezo film voltage Vpz generated by the piezo film 3 in response to the deformation of the bumper cover 22 in the vehicle width direction can be increased. Moreover, the piezo film 3 is attached to the bumper cover 22 so that both the stretching treatment direction and the polarizing treatment direction do not match the up-and-down direction. Thereby, the piezo film voltage Vpz generated in response to the deformation of the bumper cover 22 in the up-and-down direction can be reduced. Therefore, the difference between the piezo film voltage Vpz in response to the deformation in the vehicle width direction and the piezo film voltage Vpz in response to the deformation in the up-and-down direction can be increased in the vehicle collision sensor. Thus, the voltage threshold value Vth is set between the piezo film voltages Vpz, such that a collision with a pedestrian can be certainly detected by deformation of the bumper cover 22 in the vehicle width direction and that a collision to a structure fixed on the ground is not detected, which deforms the bumper cover 22 in the up-and-down direction.

Moreover, since the piezo film 3 is attached to the bumper cover 22 as a piezoelectric polymer film, the piezo film voltage Vpz corresponding to the deformation amount Q of the bumper cover 22 can be generated with sufficient accuracy.

Moreover, the piezo film 3 is not formed in the lower region LR of the bumper cover 22 which occupies an approximately lower half area. Therefore, the piezo film voltage Vpz can be further reduced in case where the bumper cover 22 is pulled downward when the bumper cover 22 collides with a structure fixed on the ground. Therefore, erroneous detection by a collision with a structure fixed on the ground can be prevented.

In addition, the lower region LR is not necessarily be an area which occupies an approximately lower half of the bumper cover 22. That is, the lower region LR may be an arbitrary area in the lower part of the bumper cover 22 where the generation of the piezo film voltage Vpz can be reduced in case where the bumper cover 22 is pulled downward.

### Other Embodiment

The present disclosure is not limited to the embodiment mentioned above, and may be modified or extended as follows.

The stretching treatment direction and the polarizing treatment direction of the piezo film 3 may not completely match the vehicle width direction. That is, the stretching treatment direction and the polarizing treatment direction may have some deviation to the vehicle width direction due to variations in the treatment or attachment process while the piezo film voltage Vpz can be increased in case where the bumper cover 22 is deformed in the vehicle width direction by collision.

Moreover, only one of the stretching process or the polarizing process may be performed to the piezoelectric polymer material to form the piezo film 3.

Moreover, the piezo film 3 may have plural stretching treatment directions or plural polarizing treatment directions.

1. A vehicle collision sensor that detects a collision to a bumper cover disposed at a front part of a vehicle, the vehicle collision sensor comprising:
a piezoelectric polymer film made of a piezoelectric polymer material to which at least one of a stretching process and a polarizing process is performed in a predetermined treatment direction, the piezoelectric polymer film being attached to an internal surface of the bumper cover such that the predetermined treatment direction matches a width direction of the vehicle and that the predetermined treatment direction does not match an up-and-down direction of the vehicle, the piezoelectric polymer film forming an output voltage corresponding to a deformation amount of the bumper cover.

2. A vehicle collision detection device comprising:
the vehicle collision sensor according to claim 1; and
a collision determining part that compares the output voltage formed by the piezoelectric polymer film or a detection voltage formed based on the output voltage with a predetermined voltage threshold value, wherein
the collision determining part determines that a collision is generated, which requires an actuation of a protection device to protect a collision object to the bumper cover of the vehicle when the output voltage or the detection voltage is more than or equal to the voltage threshold value.

3. The vehicle collision detection device according to claim 2, wherein
the piezoelectric polymer film is not formed in a lower region of the bumper cover which occupies a predetermined lower area.

4. The vehicle collision detection device according to claim 2, wherein the piezoelectric polymer film is a piezo film having a pair of electrodes and a piezo element interposed between the pair of electrodes, the piezo element being made of the piezoelectric polymer material and shaped in a thin film.
